(19) United States
(12) Patent Application Publication
(10) Pub. No.: US 2013/0159570 A1
(43) Pub. Date: Jun. 20, 2013

(54) COMPUTER DATA TRANSMITTING SYSTEM AND MOTHERBOARD USING THE SAME

(71) Applicant: BING-HENG LEE, Tu-Cheng (TW)

(72) Inventor: BING-HENG LEE, Tu-Cheng (TW)

(73) Assignee: HON HAI PRECISION INDUSTRY CO., LTD., Tu-Cheng (TW)

(21) Appl. No.: 13/426,922

(22) Filed: Mar. 22, 2012

(30) Foreign Application Priority Data
Dec. 19, 2011 (TW) 100147105

(51) Int. Cl. G06F 13/38

(52) U.S. Cl. 710/65

(57) ABSTRACT

A computer data transmitting system includes a PCI-E interface, a CPU, a first photoelectric conversion module, and a second photoelectric conversion module. The first photoelectric conversion module is electrically connected to the PCI-E interface. The second photoelectric conversion module is electrically connected to the CPU. The first photoelectric conversion module and the second photoelectric conversion module are connected to each other by at least one optical fiber. A motherboard using the computer data transmitting system is also provided.

### BACKGROUND

1. Technical Field

The present disclosure relates to data transmitting systems, particularly to a computer data transmitting system and a motherboard using the same.

2. Description of Related Art

Referring to FIG. 1, a computer data transmitting system 100 includes a Peripheral Component Interconnect Express (PCI-E) interface 10, a Central Processing Unit (CPU) 12, and a northbridge chip 14 integrated with the CPU 12. The northbridge chip 14 is electrically connected to the PCI-E interface 10 by a copper wire 16. As a data transmission speed of the CPU 12 is more than 20 gigabytes per second (Gb/s) and a data transmission speed of the copper wire 16 over a long distance is lower than 10 Gb/s, the data transmission speed of the CPU 12 is decelerated by the northbridge chip 14 to transmit the data via the copper wire 16. Therefore, the data transmission speed of the copper wire 16 over a long distance is too low to satisfy needs of some video cards or other electronic components.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the computer data transmitting system and the motherboard using the same. Moreover, in the drawings like reference numerals designate corresponding parts throughout the several views. Wherever possible, the same reference numerals are used throughout the drawings to refer to the same or like elements of an embodiment.

FIG. 1 is a block diagram of an embodiment of a computer data transmitting system.

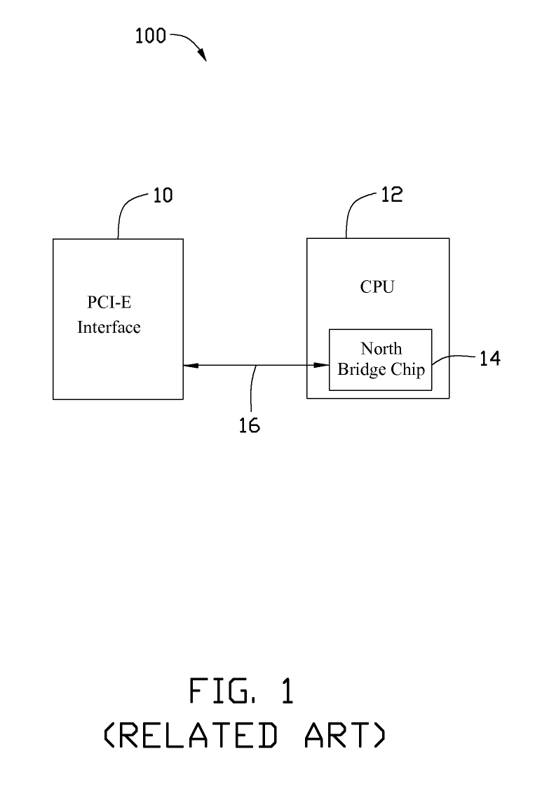

FIG. 2 is a block diagram of an embodiment of a computer data transmitting system having a CPU.

FIG. 3 is an isometric view of a motherboard assembled with the computer data transmitting system of FIG. 2 with a CPU.

### DETAILED DESCRIPTION

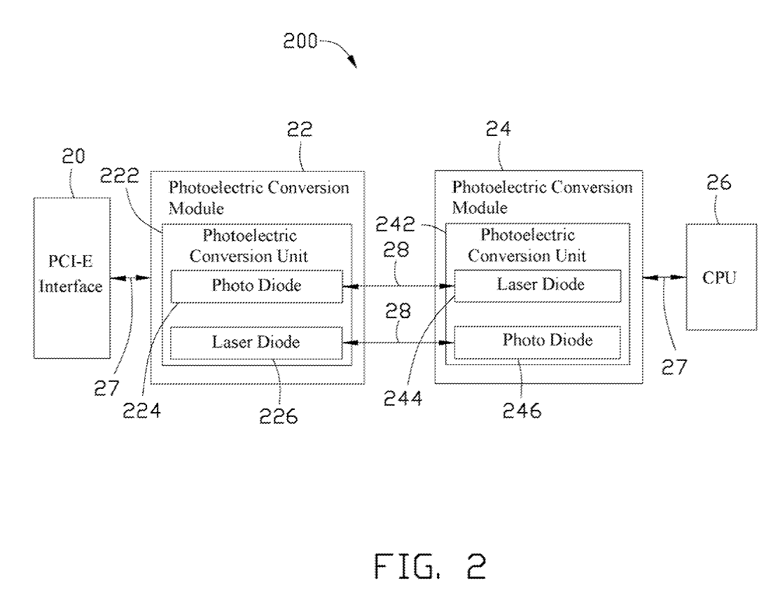

Referring to FIG. 2, an embodiment of a computer data transmitting system 200 comprises a PCI-E interface 20, a first photoelectric conversion module 22, a second photoelectric conversion module 24, and a CPU 26. One end of the PCI-E interface 20 is connected to the first photoelectric conversion module 22 by a first copper wire 27, and the other end of the PCI-E interface 20 is connected to a video card (not shown) or other fast-processing electronic component. The second photoelectric conversion module 24 is connected to the CPU 26 by a second copper wire 27. In the illustrated embodiment, the first and the second photoelectric conversion modules 22, 24 are connected to each other by two optical fibers 28. In alternative embodiments, the number of the optical fibers can be one or more.

The first photoelectric conversion module 22 comprises a photoelectric conversion unit 222. The photoelectric conversion unit 222 comprises a photo diode 224 and a laser diode 226. The second photoelectric conversion module 24 comprises a photoelectric conversion unit 242. The photoelectric conversion unit 242 comprises a laser diode 244 and a photo diode 246. In the illustrated embodiment, each of the first and the second photoelectric conversion modules 22, 24 can transmit an optical signal or an electrical signal or receive an optical signal or an electrical signal. Each of the first and the second photoelectric conversion modules 22, 24 can change an optical signal into an electrical signal or change an electrical signal into an optical signal. The photo diode 224 is connected to the laser diode 244 by one of the two optical fibers 28, and the laser diode 226 is connected to the photo diode 246 by another one of the two optical fibers 28.

Electrical signals of the CPU 26 are transmitted to the laser diode 244 by the second copper wire 27, the laser diode 244 changes the electrical signals into optical signals, the optical signals are transmitted to the photo diode 224 by one of the two optical fibers 28, and the photo diode 224 changes the optical signals into electrical signals and transmits the electrical signals to the PCI-E interface 20 by the first copper wire 27. At the same time, electrical signals transmitted to the PCI-E interface 20 by other electronic components are transmitted to the laser diode 244 by the first copper wire 27, the laser diode 244 changes the electrical signals into optical signals, the optical signals is transmitted to the photo diode 224 by one of the two optical fiber 28, and the photo diode 224 changes the optical signals into electrical signals and transmits the electrical signals to the PCI-E interface 20 by the first copper wire 27.

In alternative embodiments, the first photoelectric conversion module 22 may comprises two or more of the photoelectric conversion units 222, and the second photoelectric conversion module 24 will comprise a corresponding number of the photoelectric conversion units 242.

The first and the second photoelectric conversion modules 22, 24 connected to each other by the two optical fibers 28 connect the PCI-E interface 20 and the CPU 26, which significantly shortens the distance over which transmissions by the first and the second copper wires 27 must take place. The data transmission speed of the first and the second copper wires 27 for short distances is highly improved, at the same time, the extreme speed of transmissions by the two optical fibers 28 allows the data transmission speed of the computer data transmitting system 200 to be greatly improved.

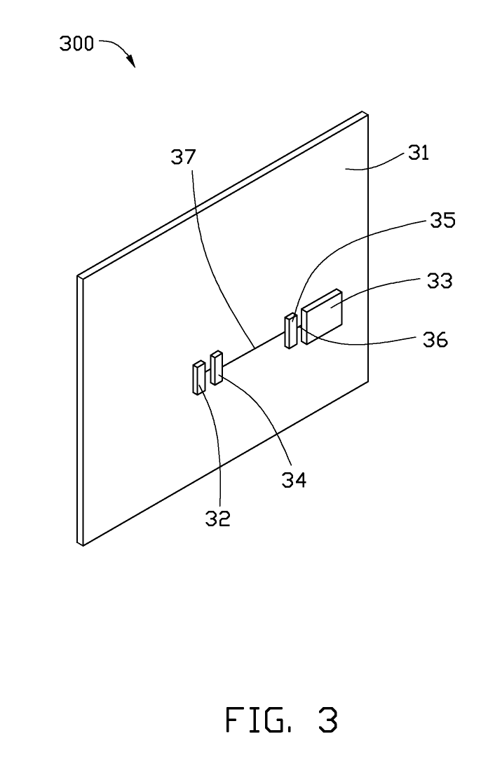

Referring to FIG. 3, another embodiment of a motherboard 300 using the computer data transmitting system 200 comprises a base board 31, a PCI-E interface 32, a first photoelectric conversion module 34, and a second photoelectric conversion module 35. In the illustrated embodiment, the base board 31 is an integrated circuit. The PCI-E interface 32, the first photoelectric conversion module 34, and the second photoelectric conversion module 35 are all fixed on the base board 31.

The first photoelectric conversion module 34 is connected to the second photoelectric conversion module 35 by optical fibers 37. The first photoelectric conversion module 34 is electrically connected to the PCI-E interface 32 by a copper wire 36, and the second photoelectric conversion module 35 is electrically connected to a CPU 33 by a copper wire 36. The first photoelectric conversion module 34 is similar to the first photoelectric conversion module 22, and the second photoelectric conversion module 35 is similar to the second photoelectric conversion module 24.

The first and the second photoelectric conversion modules 34, 35 are connected to each other by the two optical fibers 28 connect the PCI-E interface 32 and the CPU 33 and markedly shortens the transmission distance for which the copper wire 36 is utilized. The data transmission speed of the copper wire 36 for short distances is highly improved, at the same time, the high-speed data transmission capabilities of the optical fiber 37 results in a far quicker data transmission speed between the PCI-E interface 32 and the CPU 33.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A computer data transmitting system, comprising:
a Peripheral Component Interconnect Express (PCI-E) interface;
a Central Processing Unit (CPU);
a first photoelectric conversion module electrically connected to the PCI-E interface;
a second photoelectric conversion module electrically connected to the CPU, wherein the first photoelectric conversion module and the second photoelectric conversion module are connected to each other by at least one optical fiber.

2. The computer data transmitting system of claim 1, wherein first photoelectric conversion module is electrically connected to the PCI-E interface by a copper wire, and the second photoelectric conversion module is electrically connected to the CPU by a copper wire.

3. The computer data transmitting system of claim 1, wherein the first photoelectric conversion module comprises at least one photoelectric conversion unit, and each of the at least one photoelectric conversion unit comprises a photo diode and a laser diode.

4. The computer data transmitting system of claim 3, wherein the second photoelectric conversion module comprises at least one photoelectric conversion unit, and each of the at least one photoelectric conversion unit comprises a photo diode and a laser diode.

5. The computer data transmitting system of claim 4, wherein the photo diode of the first photoelectric conversion module is connected to the laser diode of the second photoelectric conversion module by one of the at least one optical fiber.

6. The computer data transmitting system of claim 4, wherein the laser diode of the first photoelectric conversion module is connected to the photo diode of the second photoelectric conversion module by one of the at least one optical fiber.

7. A motherboard, comprising:
a base board;
a Peripheral Component Interconnect Express (PCI-E) interface fixed on the base board, the PCI-E interface being connected to a Central Processing Unit (CPU) fixed on the base board;
a first photoelectric conversion module fixed on the base board;
a second photoelectric conversion module fixed on the base board, wherein the first photoelectric conversion module is electrically connected to the PCI-E interface, the second photoelectric conversion module is electrically connected to the CPU, and the first photoelectric conversion module and the second photoelectric conversion module are connected to each other by at least one optical fiber.

8. The motherboard of claim 7, wherein first photoelectric conversion module is electrically connected to the PCI-E interface by a copper wire, and the second photoelectric conversion module is electrically connected to the CPU by a copper wire.

9. The motherboard of claim 7, wherein the first photoelectric conversion module comprises at least one photoelectric conversion unit, and each of the at least one photoelectric conversion unit comprises a photo diode and a laser diode.

10. The motherboard of claim 9, wherein the second photoelectric conversion module comprises at least one photoelectric conversion unit, and each of the at least one photoelectric conversion unit comprises a photo diode and a laser diode.

11. The motherboard of claim 10, wherein the photo diode of the first photoelectric conversion module is connected to the laser diode of the second photoelectric conversion module by one of the at least one optical fiber.

12. The motherboard of claim 10, wherein the laser diode of the first photoelectric conversion module is connected to the photo diode of the second photoelectric conversion module by one of the at least one optical fiber.
